(19) United States
(12) Patent Application Publication
(10) Pub. No.: US 2009/0215945 A1
(43) Pub. Date: Aug. 27, 2009

(54) FLAMEPROOFED IMPACT-MODIFIED POLYALKYLENE TEREPHTHALATE/POLYCARBONATE COMPOSITIONS

(75) Inventors: Pierre MOULINIE, Leverkusen (DE); Vera BUCHHOLZ, Koln (DE); Eckhard WENZ, Koln (DE); Dieter WITTMANN, Leverkusen (DE)

Correspondence Address: Baker Donelson Bearman, Caldwell & Berkowitz, PC, 555 Eleventh Street, NW, Sixth Floor, Washington, DC, 20004, US

(73) Assignee: BAYER MATERIALSCIENCE AG, Leverkusen (DE)

(21) Appl. No.: 12/338,270

(22) Filed: Dec. 18, 2008

(30) Foreign Application Priority Data
Dec. 20, 2007 (DE) 102007061760.9

(51) Int. Cl. C08K 3/32

(52) U.S. Cl. 524/414

(57) ABSTRACT

The present invention relates to an impact-modified polyalkylene terephthalate/polycarbonate composition comprising
A) 41 to 97 parts by wt. (in each case based on the sum of the parts by weight of components A+B+C+D) of aromatic polycarbonate,
B) 2 to 19 parts by wt. (in each case based on the sum of the parts by weight of components A+B+C+D) of polyalkylene terephthalate,
C) 0.5 to 15 parts by wt. (in each case based on the sum of the parts by weight of components A+B+C+D) of rubber-modified graft polymer,
D) 0.5 to 25 parts by wt. (in each case based on the sum of the parts by weight of components A+B+C+D) of a salt of a phosphinic acid,

A composition of the present invention is distinguished by an optimum combination of high heat distortion temperature, good flameproofing and excellent mechanical properties (in particular high E modulus), the use of the polycarbonate compositions for the production of shaped articles and the shaped articles themselves.

### CROSS REFERENCE TO RELATED APPLICATION

This application claims priority to DE 102007061760 filed Dec. 20th, 2007, the content of which is incorporated herein by reference in its entirety.

### BACKGROUND OF THE INVENTION

1. Field of the Invention

The present invention relates to impact-modified polyalkylene terephthalate/polycarbonate compositions which comprise a salt of a phosphinic acid, the use of the impact-modified polyalkylene terephthalate/polycarbonate compositions for the production of shaped articles and the shaped articles themselves.

2. Description of Related Art

WO-A 2005/044906 discloses thermoplastic moulding compositions comprising at least one metal salt of hypophosphoric acid and at least one aromatic polycarbonate resin and a mixture thereof with a styrene-containing graft copolymer resin having a rubber content of 5-15%. The contents of the styrene-containing graft copolymer are 1040 wt. %. The moulding compositions obtained are distinguished by good flame resistance, high heat stability under processing conditions and good weather resistance. Because of the low rubber content, other properties, in particular mechanical properties, are at a low level.

WO-A 1999/57192 describes thermoplastic moulding compositions comprising 5-96 wt. % of a polyester or polycarbonate, 1-30 wt. % of a phosphinic acid salt and/or of a diphosphinic acid salt and/or polymers thereof, 1-30 wt. % of at least one organic phosphorus-containing flameproofing agent, and possible further additives.

DE-A 102004049342 discloses thermoplastic moulding compositions comprising 10-98 wt. % of thermoplastic polymer, 0.01-50 wt. % of highly branched polycarbonate or highly branched polyester or mixtures thereof, 1-40 wt. % of halogen-free flameproofing agent chosen from the group of P-containing or N-containing compounds or of P—N condensates or mixtures thereof, and possible further additives.

DE-A 19904814 describes thermoplastic moulding compositions comprising 20-98 wt. % of a polyester, 1-50 wt. % of a polycarbonate, 1-40 wt. % of a phosphinic acid salt and/or a diphosphinic acid salt and/or polymers thereof, and possible further additives.

JP-A 2001-335699 describes flameproofed resin compositions comprising two or more thermoplastic resins chosen from styrene resin, aromatic polyester resin, polyamide resin, polycarbonate resin and polyphenylene ether resin and one or more (in)organic phosphinic acid salts, and possible further additives.

JP-A 2001-261973 (Daicel Chemical Industries Ltd.) describes compositions of thermoplastic resins and (in)organic phosphinic acid salts. A combination of PBT, calcium phosphinate and PTFE is given as an example.

JP-A 2002-161211 discloses compositions of thermoplastic resins and flameproofing agents, such as salts of phosphinic and phosphoric acid and derivatives thereof. A combination of PBT, ABS, polyoxyphenylene, calcium phosphinate, an organophosphate and glass fibres is given as an example.

Flameproofing agents which are conventional according to the prior art for polyalkylene terephthalate/polycarbonate compositions are organic aromatic phosphates. These compounds can be in a low molecular weight form, in the form of a mixture of various oligomers or in the form of a mixture of oligomers with low molecular weight compounds (e.g. WO-A 99/16828 and WO-A 00/31173). The good activity as flameproofing agents is counteracted adversely by the highly plasticizing action of these compounds on the polymeric constituents, so that the heat distortion temperature of these moulding compositions is not satisfactory for many uses.

### SUMMARY OF THE INVENTION

An object of the present invention was to provide impact-modified polyalkylene terephthalate/polycarbonate compositions having an optimum combination of high heat distortion temperature, good flameproofing and excellent mechanical properties (in particular high E modulus).

It has now been found, surprisingly, that a moulding composition or a composition comprising A) polycarbonate, B) polyalkylene terephthalate, C) rubber-modified graft polymer and D) a salt of a phosphinic acid, have the desired profile of properties.

It has thus been found, surprisingly, that a composition comprising
A) 41 to 97 parts by wt., preferably 57 to 93 parts by wt., particularly preferably 64 to 83 parts by wt. (in each case based on the sum of the parts by weight of components A+B+C+D) of an aromatic polycarbonate,
B) 2 to 19 parts by wt., preferably 4 to 17 parts by wt., particularly preferably 7 to 15 parts by wt. (in each case based on the sum of the parts by weight of components A+B+C+D) of a polyalkylene terephthalate,
C) 0.5 to 15 parts by wt., preferably 2 to 11 parts by wt., particularly preferably 2 to 9 parts by wt. (in each case based on the sum of the parts by weight of components A+B+C+D) of a rubber-modified graft polymer,
D) 0.5 to 25 parts by wt., preferably 1 to 15 parts by wt., particularly preferably 7 to 12 parts by wt. (in each case based on the sum of the parts by weight of components A+B+C+D) of a salt of a phosphinic acid,
E) 0 to 20 parts by wt., preferably 1 to 15 parts by wt. (based on the sum of the parts by weight of components A+B+C+D=100) of rubber free vinyl (co)polymer,
F) 0 to 50 parts by wt., preferably 0.5 to 25 parts by wt. (in each case based on the sum of the parts by weight of components A+B+C+D=100) of at least one additive,
   wherein all the parts by weight stated in the present application are standardized such that the sum of the parts by weight of components A+B+C+D in the composition is 100, and advantageously achieve the abovementioned technical object.

Other products and methods in accordance with the present invention are provided in the detailed description and claims that follow below. Additional objects, features, and advantages will be sent forth in the description that follows, and in part, will be obvious from the description, or may be learned by practice of the invention. The objects, features, and advantages may be realized and obtained by means of the instrumentalities and combination particularly pointed out in the appended claims.

### DETAILED DESCRIPTION OF THE INVENTION

Too high a content of component B, (i.e. more than about 20 parts by wt.) may have the disadvantage that the flameproofing no longer meets the requirements imposed.

### Component A

According to the invention, the a composition according to the invention comprises as component A) a polycarbonate or a mixture of polycarbonates.

Preferred polycarbonates are those homopolycarbonates and copolycarbonates based on the bisphenols of the general formula (I)

HO-Z-OH (I)

wherein Z is a divalent organic radical having 6 to 30 C atoms, which contains one or more aromatic groups.

Preferred compounds are bisphenols of the formula (Ia)

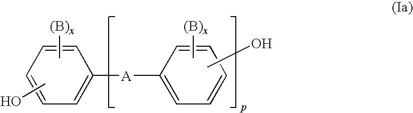

wherein
A is a single bond, C₁-C₅-alkylene, C₂-C₅-alkylidene, C₅-C₆-cycloalkylidene, —O—, —SO—, —CO—, —S—, —SO₂—, C₆-C₁₂-arylene, on to which further aromatic rings optionally containing hetero atoms can be fused,
   or a radical of the formula (II) or (III)

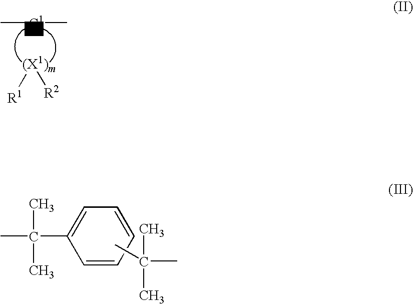

B is in each case C₁-C₁₂-alkyl, preferably methyl, or halogen, preferably chlorine and/or bromine,
x is in each case independently of one another 0, 1 or 2,
p is 1 or 0, and
R¹ and R² can be chosen individually for each X¹ and independently of one another denote hydrogen or C₁-C₆-alkyl, preferably hydrogen, methyl or ethyl,
X¹ denotes carbon and
m denotes an integer from 4 to 7, preferably 4 or 5, with the proviso that on at least one atom X¹ R¹ and R² are simultaneously alkyl.

Examples of bisphenols according to the general formula (I) are bisphenols which belong to the following groups: dihydroxydiphenyls, bis-(hydroxyphenyl)-alkanes, bis-(hydroxyphenyl)-cycloalkanes, indanebisphenols, bis-(hydroxyphenyl) sulfides, bis-(hydroxyphenyl)ethers, bis-(hydroxyphenyl) ketones, bis-(hydroxyphenyl) sulfones, bis-(hydroxyphenyl)-sulfoxides and α,α′-bis-(hydroxyphenyl)-diisopropylbenzenes.

Derivatives of the bisphenols mentioned which are accessible, for example, by alkylation or halogenation on the aromatic rings of the bisphenols mentioned are also examples of bisphenols according to the general formula (I).

Examples of bisphenols according to the general formula (I) are in particular the following compounds: hydroquinone, resorcinol, 4,4′-dihydroxydiphenyl, bis-(4-hydroxyphenyl) sulfide, bis-(4-hydroxyphenyl) sulfone, bis-(3,5-dimethyl-4-hydroxyphenyl)-methane, bis-(3,5-dimethyl-4-hydroxyphenyl) sulfone, 1,1-bis-(3,5-dimethyl-4-hydroxyphenyl)-p/m-diisopropylbenzene, 1,1-bis-(4-hydroxyphenyl)-1-phenyl-ethane, 1,1-bis-(3,5-dimethyl-4-hydroxyphenyl)-cyclohexane, 1,1-bis-(4-hydroxyphenyl)-3-methylcyclohexane, 1,1-bis-(4-hydroxyphenyl)-3,3-dimethylcyclohexane, 1,1-bis-(4-hydroxyphenyl)-4-methylcyclohexane, 1,1-bis-(4-hydroxyphenyl)-cyclohexane, 1,1-bis-(4-hydroxyphenyl)-3,3,5-trimethylcyclohexane, 2,2-bis-(3,5-dichloro-4-hydroxyphenyl)-propane, 2,2-bis-(3-methyl-4-hydroxyphenyl)-propane, 2,2-bis-(3,5-dimethyl-4-hydroxyphenyl)-propane, 2,2-bis-(4-hydroxyphenyl)-propane (i.e. bisphenol A), 2,2-bis-(3-chloro-4-hydroxyphenyl)-propane, 2,2-bis-(3,5-dibromo-4-hydroxyphenyl)-propane, 2,4-bis-(4-hydroxyphenyl)-2-methylbutane, 2,4-bis-(3,5-dimethyl-4-hydroxy-phenyl)-2-methylbutane, α,α′-bis-(4-hydroxyphenyl)-o-diisopropylbenzene, α,α′-bis-(4-hydroxyphenyl)-m-diisopropylbenzene (i.e. bisphenol M), α,α′-bis-(4-hydroxyphenyl)-p-diisopropylbenzene and indanebisphenol.

Particularly preferred polycarbonates are the homopolycarbonate based on bisphenol A, the homopolycarbonate based on 1,1-bis-(4-hydroxyphenyl)-3,3,5-trimethylcyclohexane and the copolycarbonates based on the two monomers bisphenol A and 1,1-bis-(4-hydroxyphenyl)-3,3,5-trimethylcyclohexane.

The bisphenols according to the general formula (I) which are described can be prepared by known processes, e.g. from the corresponding phenols and ketones.

The bisphenols mentioned and processes for their preparation are described, for example, in the monograph H. Schnell, “Chemistry and Physics of Polycarbonates”, Polymer Reviews, volume 9, p. 77-98, Interscience Publishers, New York, London, Sydney, 1964 and in U.S. Pat. No. 3,028,635, in U.S. Pat. No. 3,062,781, in U.S. Pat. No. 2,999,835, in U.S. Pat. No. 3,148,172, in U.S. Pat. No. 2,991,273, in U.S. Pat. No. 3,271,367, in U.S. Pat. No. 4,982,014, in U.S. Pat. No. 2,999,846, in DE-A 1 570 703, in DE-A 2 063 050, in DE-A 2 036 052, in DE-A 2 211 956, in DE-A 3 832 396, and in FR-A 1 561 518 and in the Japanese laid-open specifications with the application numbers JP-A 62039 1986, JP-A 62040 1986 and JP-A 105550 1986.

1,1-Bis-(4-hydroxyphenyl)-3,3,5-trimethylcyclohexane and its preparation are described e.g. in U.S. Pat. No. 4,982,014.

Indanebisphenols and their preparation are described, for example, in U.S. Pat. No. 3,288,864, in JP-A 60 035 150 and in U.S. Pat. No. 4,334,106. Indanebisphenols can be prepared, for example, from isopropenylphenol or derivatives thereof or from dimers of isopropenylphenol or derivatives thereof in the presence of a Friedel-Crafts catalyst in organic solvents.

Polycarbonates can be prepared by known processes. Suitable processes for the preparation of polycarbonates are, for example, the preparation from bisphenols with phosgene by the interfacial process or from bisphenols with phosgene by the process in a homogeneous phase, the so-called pyridine process, or from bisphenols with carbonic acid esters by the melt transesterification process. These preparation processes are described e.g. in H. Schnell, “Chemistry and Physics of Polycarbonates”, Polymer Reviews, volume 9, p. 31-76, Interscience Publishers, New York, London, Sydney, 1964. The preparation processes mentioned are also described in D. Freitag, U. Grigo, P. R. Müller, H. Nouvertne, “Polycarbonates” in Encyclopedia of Polymer Science and Engineering, volume 11, second edition, 1988, pages 648 to 718 and in U. Grigo, K. Kircher and P. R. Müller “Polycarbonate” in Becker, Braun, Kunststoff-Handbuch, volume 3/1, Polycarbonate, Polyacetale, Polyester, Celluloseester, Carl Hanser Verlag Munich, Vienna 1992, pages 117 to 299 and in D. C. Prevorsek, B. T. Debona and Y. Kesten, Corporate Research Center, Allied Chemical Corporation, Morristown, N.J. 07960, “Synthesis of Poly(estercarbonate) Copolymers” in Journal of Polymer Science, Polymer Chemistry Edition, vol. 19, 75-90 (1980).

The melt transesterification process is described in particular, for example, in H. Schnell, “Chemistry and Physics of Polycarbonates”, Polymer Reviews, volume 9, p. 44 to 51, Interscience Publishers, New York, London, Sydney, 1964 and in DE-A 1 031 512.

Raw materials and auxiliary substances having a low degree of contamination are preferably employed in the preparation of polycarbonate. In the preparation by the melt transesterification process in particular, the bisphenols employed and the carbonic acid derivatives employed should as far as possible be free from alkali metal ions and alkaline earth metal ions. Raw materials which are pure in this way are obtainable, for example, by recrystallizing, washing or distilling the carbonic acid derivatives, for example carbonic acid esters, and the bisphenols.

The polycarbonates which are suitable according to the invention preferably have a weight-average molar mass ( M̅_{w}), which can be determined e.g. by ultracentrifugation or scattered light measurements, of from 10,000 to 200,000 g/mol. They particularly preferably have a weight-average molar mass of from 12,000 to 80,000 g/mol, particularly preferably 20,000 to 35,000 g/mol.

The average molar mass of the polycarbonates according to the invention can be adjusted, for example, in a known manner by an appropriate amount of chain terminators. The chain terminators can be employed individually or as a mixture of various chain terminators.

Both monophenols and monocarboxylic acids are suitable chain terminators. Suitable monophenols are e.g. phenol, p-chlorophenol, p-tert-butylphenol, cumylphenol or 2,4,6-tribromophenol, as well as long-chain alkylphenols, such as e.g. 4-(1,1,3,3-tetramethylbutyl)-phenol, or monoalkylphenols or dialkylphenols having a total of 8 to 20 C atoms in the alkyl substituents, such as e.g. 3,5-di-tert-butylphenol, p-tert-octylphenol, p-dodecylphenol, 2-(3,5-dimethyl-heptyl)-phenol or 4-(3,5-dimethyl-heptyl)-phenol. Suitable monocarboxylic acids are benzoic acid, alkylbenzoic acids and halogenobenzoic acids.

Preferred chain terminators are phenol, p-tert-butylphenol, 4-(1,1,3,3-tetramethylbutyl)-phenol and cumylphenol.

The amount of chain terminators is preferably between 0.25 and 10 mol %, based on the sum of the moles of the particular bisphenols employed.

The polycarbonates which are suitable according to the invention can be branched in a known manner, and in particular preferably by the incorporation of branching agents which are trifunctional or more than trifunctional. Suitable branching agents are e.g. those having three or more than three phenolic groups, or those having three or more than three carboxylic acid groups.

Suitable branching agents are, for example, phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tris-(4-hydroxyphenyl)-ethane, tri-(4-hydroxyphenyl)-phenylmethane, 2,2-bis-[4,4-bis-(4-hydroxyphenyl)-cyclohexyl]-propane, 2,4-bis-(4-hydroxyphenyl-isopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)-phenyl)-terephthalic acid ester, tetra-(4-hydroxyphenyl)-methane, tetra-(4-(4-hydroxyphenyl-isopropyl)-phenoxy)-methane and 1,4-bis-(4′,4″-dihydroxytriphenyl)-methylbenzene, as well as 2,4-dihydroxybenzoic acid, trimesic acid, cyanuric chloride, 3,3-bis-(3-methyl-4-hydroxyphenyl)-2-oxo-2,3-dihydroindole, trimesic acid trichloride and α,α′,α″-tris-(4-hydroxyphenyl)-1,3,5-triisopropyl-benzene.

Preferred branching agents are 1,1,1-tris-(4-hydroxyphenyl)-ethane and 3,3-bis-(3-methyl-4-hydroxyphenyl)-2-oxo-2,3-dihydroindole.

The amount of branching agent optionally to be employed is preferably 0.05 mol % to 2 mol %, based on the moles of bisphenols employed.

In the case of the preparation of the polycarbonate by the interfacial process, for example, the branching agents can be initially introduced with the bisphenols and the chain terminators in the aqueous alkaline phase, or can be added as a solution in an organic solvent together with the carbonic acid derivatives. In the case of a transesterification process, the branching agents are preferably metered in together with the dihydroxyaromatics or bisphenols.

Catalysts which are preferably to be employed in the preparation of polycarbonate by the melt transesterification process are the ammonium salts and phosphonium salts known from the literature (see, for example, U.S. Pat. No. 3,442,864, JP-A-14742/72, U.S. Pat. No. 5,399,659 and DE-A 19 539 290).

Copolycarbonates can also be used. Copolycarbonates in the context of the invention are, in particular, polydiorganosiloxane/polycarbonate block copolymers, the weight-average molar mass ( M̅_{w}) of which is preferably 10,000 to 200,000 g/mol, particularly preferably 20,000 to 80,000 g/mol (determined by gel chromatography after prior calibration by light scattering measurement or ultracentrifugation). The content of aromatic carbonate structural units in the polydiorganosiloxane/polycarbonate block copolymers is preferably 75 to 97.5 wt. %, particularly preferably 85 to 97 wt. %. The content of polydiorganosiloxane structural units in the polydiorganosiloxane/polycarbonate block copolymers is preferably 25 to 2.5 wt. %, particularly preferably 15 to 3 wt. %. The polydiorganosiloxane/polycarbonate block copolymers can be prepared, for example, starting from polydiorganosiloxanes containing α,ω-bishydroxyaryloxy end groups and having an average degree of polymerization of preferably Pₙ=5 to 100, particularly preferably Pₙ=20 to 80.

Conventional additives, such as e.g. mould release agents, can be admixed to the polycarbonates in the melt or applied to the surface. Preferably, the polycarbonates used already contain mould release agents before compounding with the other components of the moulding compositions according to the invention.

### Component B

According to the invention, the compositions comprise as component B) one or a mixture of two or more different polyalkylene terephthalates. Polyalkylene terephthalates in the context of the invention are polyalkylene terephthalates which are derived from terephthalic acid (or its reactive derivatives) and alkanediols, for example based on propylene glycol or butanediol. According to the invention, polyethylene terephthalate, polybutylene terephthalate and/or polytrimethylene terephthalate are employed as component B), most preferably polybutylene terephthalate.

Polyalkylene terephthalates in the context of the invention are reaction products of aromatic dicarboxylic acids or their reactive derivatives (e.g. dimethyl esters or anhydrides) and aliphatic, cycloaliphatic or araliphatic diols and mixtures of these reaction products.

Preferred polyalkylene terephthalates can be prepared from terephthalic acid (or its reactive derivatives) and aliphatic or cycloaliphatic diols having 2 to 10 C atoms by known methods (Kunststoff-Handbuch, vol. VIII, p. 695 et seq., Karl-Hanser-Verlag, Munich 1973).

Preferred polyalkylene terephthalates contain at least 80, preferably 90 mol %, based on the dicarboxylic acid, of terephthalic acid radicals and at least 80, preferably at least 90 mol %, based on the diol component, of radicals of ethylene glycol and/or propane-1,3-diol and/or butane-1,4-diol.

The preferred polyalkylene terephthalates can contain, in addition to terephthalic acid radicals, up to 20 mol % of radicals of other aromatic dicarboxylic acids having 8 to 14 C atoms or aliphatic dicarboxylic acids having 4 to 12 C atoms, such as radicals of phthalic acid, isophthalic acid, naphthalene-2,6-dicarboxylic acid, 4,4′-diphenyldicarboxylic acid, succinic, adipic and sebacic acid, azelaic acid, cyclohexanediacetic acid and cyclohexanedicarboxylic acid.

The preferred polyalkylene terephthalates can contain, in addition to radicals of ethylene glycol or propane-1,3-diol or butane-1,4-diol, up to 20 mol % of other aliphatic diols having 3 to 12 C atoms or cycloaliphatic diols having 6 to 21 C atoms, e.g. radicals of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol, 2-ethylhexane-1,6-diol, 2,2-diethylpropane-1,3-diol, hexane-2,5-diol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(4-β-hydroxyethoxyphenyl)-propane and 2,2-bis-(4-hydroxypropoxyphenyl)-propane (DE-A 24 07 674, 24 07 776 and 27 15 932).

The polyalkylene terephthalates can be branched by incorporation of relatively small amounts of 3- or 4-hydric alcohols or 3- or 4-basic carboxylic acids, such as are described e.g. in DE-A 19 00 270 and U.S. Pat. No. 3,692,744. Examples of preferred branching agents are trimesic acid, trimellitic acid, trimethylolethane and -propane and pentaerythritol.

It is advisable in some cases not to use more than about 1 mol % of the branching agent, based on the acid component.

Polyalkylene terephthalates which have been prepared solely from terephthalic acid or reactive derivatives thereof (e.g. dialkyl esters thereof, such as dimethyl terephthalate) and ethylene glycol and/or propane-1,3-diol and/or butane-1,4-diol (polyethylene and polybutylene terephthalate) and mixtures of these polyalkylene terephthalates are particularly preferred.

Preferred polyalkylene terephthalates are also copolyesters which can be prepared from at least two of the abovementioned acid components and/or from at least two of the abovementioned alcohol components, and particularly preferred copolyesters are poly(ethylene glycol/butane-1,4-diol) terephthalates.

The polyalkylene terephthalates in general have an intrinsic viscosity of from approx. 0.4 to 1.5 dl/g, preferably 0.5 to 1.3 dl/g, in each case measured in phenol/o-dichlorobenzene (1:1 parts by wt.) at 25° C.

Preferably, the polyesters prepared according to the invention can also be employed in a mixture with other polyesters and/or further polymers. Mixtures of polyalkylene terephthalates with other polyesters are particularly preferably employed.

Conventional additives, such as e.g. mould release agents, stabilizers and/or flow agents, can be admixed to the polyesters in the melt or applied to the surface.

### Component C

Component C includes one or more graft polymers of
C.1 5 to 95, preferably 30 to 90 wt. % of at least one vinyl monomer on
C.2 95 to 5, preferably 70 to 10 wt. % of at least one graft base chosen from the group consisting of diene rubbers, EP(D)M rubbers (i.e. those based on ethylene/propylene and optionally diene) and acrylate, polyurethane, silicone, silicone/acrylate, chloroprene and ethylene/vinyl acetate rubbers.

The graft base C.2 in general has an average particle size (d₅₀ value) of from 0.05 to 10 μm, preferably 0.1 to 5 μm, particularly preferably 0.2 to 1 μm.

Monomers C.1 are preferably mixtures of
C.1.1 50 to 99 parts by wt. of vinylaromatics and/or vinylaromatics substituted on the nucleus (such as styrene, α-methylstyrene, p-methylstyrene and p-chlorostyrene) and/or (meth)acrylic acid (C₁-C₈)-alkyl esters (such as methyl methacrylate and ethyl methacrylate) and
C.1.2 1 to 50 parts by wt. of vinyl cyanides (unsaturated nitriles, such as acrylonitrile and methacrylonitrile) and/or (meth)acrylic acid C₁-C₈-alkyl esters, such as methyl methacrylate, n-butyl acrylate and t-butyl acrylate, and/or derivatives (such as anhydrides and imides) of unsaturated carboxylic acids, for example maleic anhydride and N-phenyl-maleimide.

Preferred monomers C.1.1 are chosen from at least one of the monomers styrene, α-methylstyrene and methyl methacrylate, and preferred monomers C.1.2 are chosen from at least one of the monomers acrylonitrile, maleic anhydride and methyl methacrylate. Particularly preferred monomers are C.1.1 styrene and C.1.2 acrylonitrile.

Preferred graft bases C.2 are silicone/acrylate rubbers, diene rubbers (for example based on butadiene and isoprene) or mixtures of diene rubbers. Diene rubbers in the context according to the invention are also to be understood as meaning copolymers of diene rubbers or mixtures thereof with further copolymerizable monomers (e.g. according to C.1.1 and C.1.2). The graft bases B.2 in general have a glass transition temperature of <10° C., preferably <0° C., particularly preferably <−10° C.

Particularly preferred polymers C are, for example, ABS polymers (emulsion, bulk and suspension ABS) such as are described e.g. in DE-OS 2 035 390 (=U.S. Pat. No. 3,644,574) or in DE-OS 2 248 242 (=GB 1 409 275) and in Ullmanns, Enzyklopätdie der Technischen Chemie, vol. 19 (1980), p. 280 et seq. The gel content of the graft base C.2 is at least 20 wt. %, in the case of graft bases C.2 prepared in emulsion polymerization preferably at least 40 wt. % (measured in toluene).

Preferably, the graft polymer of components C.1 and C.2 has a core-shell structure, wherein component C.1 forms the shell (also called casing) and component C.2 forms the core (see e.g. Ullmann's Encyclopedia of Industrial Chemistry, VCH-Verlag, vol. A21, 1992, page 635 and page 656).

The graft copolymers C can be prepared, for example, by free-radical polymerization, e.g. by emulsion, suspension, solution or bulk polymerization, preferably by emulsion or bulk polymerization.

Particularly suitable graft rubbers are also ABS polymers which are prepared in the emulsion polymerization process by redox initiation with an initiator system of organic hydroperoxide and ascorbic acid in accordance with U.S. Pat. No. 4,937,285.

Since as is known the grafting monomers are not necessarily grafted completely on to the graft base during the grafting reaction, according to the invention graft polymers C are also understood as meaning those products which are produced by (co)polymerization of the grafting monomers in the presence of the graft base and are also obtained during the working up.

Suitable acrylate rubbers according to C.2 of the polymers C are preferably polymers of acrylic acid alkyl esters, optionally with up to 40 wt. %, based on B.2, of other polymerizable ethylenically unsaturated monomers. The preferred polymerizable acrylic acid esters include C₁ to C₈-alkyl esters, for example methyl, ethyl, butyl, n-octyl and 2-ethylhexyl esters, haloalkyl esters, preferably halo-C₁-C₈-alkyl esters, such as chloroethyl acrylate, and mixtures of these monomers.

For crosslinking, monomers having more than one polymerizable double bond can be copolymerized. Preferred examples of crosslinking monomers include esters of unsaturated monocarboxylic acids having 3 to 8 C atoms and unsaturated monohydric alcohols having 3 to 12 C atoms, or of saturated polyols having 2 to 4 OH groups and 2 to 20 C atoms, such as ethylene glycol dimethacrylate and allyl methacrylate; polyunsaturated heterocyclic compounds, such as trivinyl and triallyl cyanurate; polyfunctional vinyl compounds, such as di- and trivinylbenzenes; but also triallyl phosphate and diallyl phthalate. Preferred crosslinking monomers are allyl methacrylate, ethylene glycol dimethacrylate, diallyl phthalate and heterocyclic compounds which contain at least three ethylenically unsaturated groups. Particularly preferred crosslinking monomers are the cyclic monomers triallyl cyanurate, triallyl isocyanurate, triacryloylhexahydro-s-triazine and triallylbenzenes. The amount of the crosslinking monomers is preferably 0.02 to 5, in particular 0.05 to 2 wt. %, based on the graft base C.2. In the case of cyclic crosslinking monomers having at least three ethylenically unsaturated groups, it is advantageous to limit the amount to less than 1 wt. % of the graft base C.2 in some cases.

Preferred “other” polymerizable ethylenically unsaturated monomers which can optionally serve for preparation of the graft base C.2 in addition to the acrylic acid esters are e.g. acrylonitrile, styrene, α-methylstyrene, acrylamides, vinyl C₁-C₆-alkyl ethers, methyl methacrylate and butadiene. Preferred acrylate rubbers as the graft base C.2 are emulsion polymers which have a gel content of at least 60 wt. %. Suitable silicone rubbers according to C.2 can be prepared by emulsion polymerization, as described, for example, in U.S. Pat. No. 2,891,920 and U.S. Pat. No. 3,294,725. Further suitable graft bases according to C.2 are silicone rubbers having grafting-active sites, such as are described in DE-OS 3 704 657, DE-OS 3 704 655, DE-OS 3 631 540 and DE-OS 3 631 539.

According to the invention, silicone/acrylate rubbers are also suitable as graft bases C.2. These silicone/acrylate rubbers are composite rubbers having grafting-active sites containing a silicone rubber content of 10-90 wt. % and a polyalkyl (meth)acrylate rubber content of 90 to 10 wt. %, the two rubber components mentioned penetrating each other in the composite rubber, so that they cannot be separated substantially from one another. If the content of the silicone rubber component in the composite rubber is too high, the finished resin compositions may have adverse surface properties and cannot be coloured so readily. On the other hand, if the content of the polyalkyl (meth)acrylate rubber component in the composite rubber is too high, the impact strength of the finished resin composition may be adversely influenced in some cases. Silicone/acrylate rubbers are known and are described, for example, in U.S. Pat. No. 5,807,914, EP 430134 and U.S. Pat. No. 4,888,388. A graft polymer prepared in emulsion polymerization with C.1 methyl methacrylate and C.2 silicone/acrylate composite rubber is preferably employed. The gel content of the graft base C.2 is determined at 25° C. in a suitable solvent (M. Hoffmann, H. Krömer, R. Kuhn, Polymeranalytik I und II, Georg Thieme-Verlag, Stuttgart 1977).

The average particle size d₅₀ is the diameter above and below which in each case 50 wt. % of the particles lie. It can be determined by means of ultracentrifuge measurement (W. Scholtan, H. Lange, Kolloid, Z. und Z. Polymere 250 (1972), 782-796).

### Component D

The salt of a phosphinic acid (component D) in the context according to the invention is to be understood as meaning the salt of a phosphinic acid with any desired metal cation. Mixtures of salts which differ in their metal cation can also be employed. The metal cations are the cations of metals of main group 1 (alkali metals, preferably Li⁺, Na⁺, K⁺), of main group 2 (alkaline earth metals; preferably Mg²⁺, Ca²⁺, Sr²⁺, Ba²⁺, particularly preferably Ca²⁺) or of main group 3 (elements of the boron group; preferably Al³⁺) and/or of subgroup 2, 7 or 8 (preferably Zn²⁺, Mn²⁺, Fe²⁺, Fe³⁺) of the periodic table.

A salt or a mixture of salts of a phosphinic acid of the formula (IV) is preferably employed

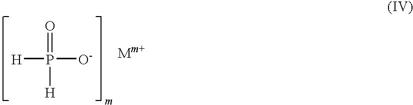

wherein M^{m+} is a metal cation of main group 1 (alkali metals; m=1), main group 2 (alkaline earth metals; m=2) or of main group 3 (m=3) or of subgroup 2, 7 or 8 (wherein m denotes an integer from 1 to 6, preferably 1 to 3 and particularly preferably 2 or 3) of the periodic table.

Particularly preferably, in formula (IV)

for m=1 the metal cations M⁺=Li⁺, Na⁺, K⁺,
for m=2 the metal cations M²⁺=Mg²⁺, Ca²⁺, Sr²⁺, Ba²⁺ and
for m=3 the metal cations M³⁺=Al³⁺,
Ca²⁺ (m=2) and Al³⁺ (m=3) are very preferred.

In a preferred embodiment, the average particle size d₅₀ of the phosphinic acid salt (component D) is less than 80 μm, preferably less than 60 μm, and d₅₀ is particularly preferably between 10 μm and 55 μm. The average particle size d₅₀ is the diameter above and below which in each case 50 wt. % of the particles lie. Mixtures of salts which differ in their average particle size d₅₀ can also be employed if desired for any reason.

These particle size d₅₀ requirements of the phosphinic acid salt are in each case associated with the technical effect that the flameproofing efficiency of the phosphinic acid salt is increased.

The phosphinic acid salt can be employed either by itself and/or in combination with other phosphorus-containing flameproofing agents. The compositions according to the invention are preferably free from phosphorus-containing flameproofing agents chosen from the group of mono- and oligomeric phosphoric and phosphonic acid esters, phosphonate-amines and phosphazenes. These other phosphorus-containing flameproofing agents such as mono- and oligomeric phosphoric and phosphonic acid esters have a negative effect (when compared with phosphinic acid salts) with regard to the heat distortion temperature of the molding compositions.

### Component E

Component E is optional and can include one or more thermoplastic vinyl (co)polymers E.1.

Suitable vinyl (co)polymers E.1 are polymers of at least one monomer from the group of vinylaromatics, vinyl cyanides (unsaturated nitriles), (meth)acrylic acid (C₁-C₈)-alkyl esters, unsaturated carboxylic acids and derivatives (such as anhydrides and imides) of unsaturated carboxylic acids. (Co)polymers which are suitable in particular are those of
E.1.1 50 to 99, preferably 60 to 80 parts by wt. of vinylaromatics and/or vinylaromatics substituted on the nucleus, such as styrene, α-methylstyrene, p-methylstyrene and p-chlorostyrene, and/or (meth)acrylic acid (C₁-C₈)-alkyl esters, such as methyl methacrylate and ethyl methacrylate, and
E.1.2 1 to 50, preferably 20 to 40 parts by wt. of vinyl cyanides (unsaturated nitriles), such as acrylonitrile and methacrylonitrile, and/or (meth)acrylic acid (C₁-C₈)-alkyl esters, such as methyl methacrylate, n-butyl acrylate and t-butyl acrylate, and/or unsaturated carboxylic acids, such as maleic acid, and/or derivatives, such as anhydrides and imides, of unsaturated carboxylic acids, for example maleic anhydride and N-phenylmaleimide.

The vinyl (co)polymers E.1 are resinous, thermoplastic and rubber-free. The copolymer of E.1.1 styrene and E.1.2 acrylonitrile is particularly preferred.

The (co)polymers according to E.1 are known and can be prepared by free-radical polymerization, in particular by emulsion, suspension, solution or bulk polymerization. The (co)polymers preferably have average molecular weights Mw (weight-average, determined by light scattering or sedimentation) of between 15,000 and 200,000.

### Component F

The composition can optionally comprise further a commercially available additive according to component F, such as flameproofing synergists, antidripping agents (for example compounds of the substance classes of fluorinated polyolefins, of silicones and aramid fibres), lubricants and mould release agents (for example pentaerythritol tetrastearate), nucleating agents, stabilizers, antistatics (for example conductive carbon blacks, carbon fibres, carbon nanotubes and organic antistatics, such as polyalkylene ethers, alkylsulfonates or polyamide-containing polymers), acids, fillers and reinforcing substances (for example glass fibres or carbon fibres, mica, kaolin, talc, CaCO₃ and glass flakes) and dyestuffs and pigments. The fluorinated polyolefins are preferably employed in the form of a coagulated mixture of emulsions of fluorinated polyolefins with emulsions of a vinyl (co)polymer E.1, particularly preferably with emulsions of a copolymer based on styrene/acrylonitrile.

### Preparation of the Moulding Compositions and Shaped Articles

The thermoplastic moulding compositions according to the invention can be prepared by mixing the particular constituents in a known manner and subjecting the mixture to melt compounding and melt extrusion at a temperature of from 260° C. to 300° C. in conventional units, such as internal kneaders, extruders and twin-screw extruders.

The mixing of the individual constituents can be carried out in a known manner either successively or simultaneously, and in particular either at about 20° C. (room temperature) or at a higher temperature.

The invention likewise provides processes for the preparation of the moulding compositions and the use of the moulding compositions for the production of shaped articles and the mouldings themselves.

The moulding compositions according to the invention can be used for the production of all types of shaped articles. These can be produced, for example, by injection moulding, extrusion and blow moulding processes. A further form of processing is the production of shaped articles by thermoforming from previously produced sheets or films.

Examples of such shaped articles include films, profiles, housing components of all types, e.g. for domestic appliances, such as televisions, juice presses, coffee machines and mixers; for office machines, such as monitors, flatscreens, notebooks, printers and copiers; sheets, tubes, electrical installation conduits, windows, doors and further profiles for the building sector (interior finishing and exterior uses) and electrical and electronic components, such as switches, plugs and sockets, and vehicle body or interior components for utility vehicles, in particular for the automobile sector.

The moulding compositions according to the invention can also be used in particular, for example, for the production of the following shaped articles or mouldings: interior finishing components for rail vehicles, ships, aircraft, buses and other motor vehicles, housing of electrical equipment containing small transformers, housing for equipment for processing and transmission of information, housing and lining of medical equipment, massage equipment and housing therefor, toy vehicles for children, planar wall elements, housing for safety equipment and for televisions, thermally insulated transportation containers, mouldings for sanitary and bath fittings, cover grids for ventilator openings and housing for garden equipment.

The following examples serve to explain the invention further.

### EXAMPLES

### Component A

Linear polycarbonate based on bisphenol A having a relative solution viscosity of ηᵣₑₗ=1.315±0.05 measured in CH₂Cl₂ as the solvent at 25° C. and a concentration of 0.5 g/100 ml.

### Component B-1

Linear polyethylene terephthalate having a melt viscosity according to DIN 54 811 of 275 Pa·s at 265° C. and at a shear rate of 500 s⁻¹ (Invista RT-6012, INVISTA Resins & Fibers GmbH, Hattersheim am Main, Germany).

### Component B-2

Linear polybutylene terephthalate having a melt viscosity according to DIN 54 811 of 622 Pa·s at 240° C. and at a shear rate of 500 s⁻¹ (Invista RT-6012, INVISTA Resins & Fibers GmbH, Hattersheim am Main, Germany).

### Component C

ABS graft polymer prepared by emulsion polymerization of 43 wt. %, based on the ABS polymer, of a mixture of 27 wt. % of acrylonitrile and 73 wt. % of styrene in the presence of 57 wt. %, based on the ABS polymer, of a polybutadiene rubber crosslinked in particle form (average particle diameter d₅₀=0.3 to 0.4 μm).

### Component D

### Component D-1 (comparison)

Oligophosphate based on bisphenol A

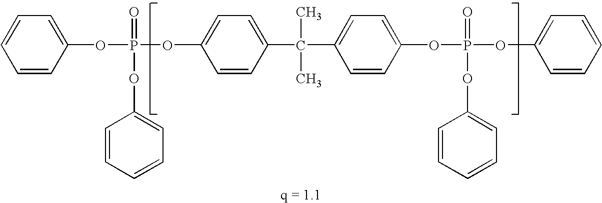

### Component D-2

Calcium phosphinate, average particle size d₅₀=50 μm.

### Component F

Component F-1: Coagulated mixture of emulsions of fluorinated polyolefins with emulsions of a copolymer based on styrene/acrylonitrile (Blendex® 449 from Chemtura).
Component F-2: Pentaerythritol tetrastearate
Component F-3: Irganox B900 (manufacturer: Ciba Specialty Chemicals Inc., Basle, Switzerland)

### Preparation and Testing of the Moulding Compositions

The starting substances listed in Table 1 are compounded and granulated on a twin-screw extruder (ZSK-25) (Werner und Pfleiderer) at a speed of rotation of 225 rpm and a throughput of 18 kg/h at a machine temperature of 260° C.

The finished granules are processed on an injection moulding machine to give the corresponding test specimens (melt temperature 260° C., mould temperature 80° C., melt front speed 240 mm/s).

Characterization is carried out in accordance with ISO 527-1/-2 (tensile E modulus), ISO 306 (Vicat softening temperature, method B with a load of 50 N and a heating rate of 120 K/h), ISO 75-1/-2 (heat distortion temperature HDT, method Af with a flexural stress of 1.80 MPa and method Bf with a flexural stress of 0.45 MPa), and UL 94 V in a thickness of 3.0 mm and 1.5 mm.

It can be seen from Table 1 that only the compositions according to the invention in Examples 4, 5, 6 and 10, 11, 12 with a combination of polycarbonate, polyester and calcium phosphinate achieve the object according to the invention, i.e. give a combination of high E modulus, high heat distortion temperature and good performance in the UL94V test.

While the foregoing description teaches the principles of the present invention, with examples provided for the purpose of illustration, it will be understood that the practice of the invention encompasses all variations, adaptations, or modifications considered by those skilled in the art and encompassed by the following claims. As used herein and in the following claims, articles such as “a”, “an”, “the” can connote singular or plural.

TABLE 1
Compositions and their properties

| | | 1 | 2 | 3 | | | | 7 | 8 | 9 | | | |
|---|---|---|---|---|---|---|---|---|---|---|---|---|---|
| | | comp. | comp. | comp. | 4 | 5 | 6 | comp. | comp. | comp. | 10 | 11 | 12 |
| Composition | | | | | | | | | | | | | |
| A | pt. by wt. | 75.7 | 69.6 | 63.5 | 75.7 | 69.6 | 63.5 | 75.7 | 69.6 | 63.5 | 75.7 | 69.6 | 63.5 |
| B-1 | pt. by wt. | 6.1 | 12.2 | 18.3 | 6.1 | 12.2 | 18.3 | | | | | | |
| B-2 | pt. by wt. | | | | | | | 6.1 | 12.2 | 18.3 | 6.1 | 12.2 | 18.3 |
| C | pt. by wt. | 8.1 | 8.1 | 8.1 | 8.1 | 8.1 | 8.1 | 8.1 | 8.1 | 8.1 | 8.1 | 8.1 | 8.1 |
| D-1 | pt. by wt. | 10.1 | 10.1 | 10.1 | | | | 10.1 | 10.1 | 10.1 | | | |
| D-2 | pt. by wt. | | | | 10.1 | 10.1 | 10.1 | | | | 10.1 | 10.1 | 10.1 |
| F-1 | pt. by wt. | 1.0 | 1.0 | 1.0 | 1.0 | 1.0 | 1.0 | 1.0 | 1.0 | 1.0 | 1.0 | 1.0 | 1.0 |
| F-2 | pt. by wt. | 0.2 | 0.2 | 0.2 | 0.2 | 0.2 | 0.2 | 0.2 | 0.2 | 0.2 | 0.2 | 0.2 | 0.2 |
| F-3 | pt. by wt. | 0.2 | 0.2 | 0.2 | 0.2 | 0.2 | 0.2 | 0.2 | 0.2 | 0.2 | 0.2 | 0.2 | 0.2 |
| Properties | | | | | | | | | | | | | |
| Tensile E modulus | MPa | 2604 | 2628 | 2653 | 2786 | 2871 | 2942 | 2545 | 2586 | 2624 | 2757 | 2797 | 2843 |
| (ISO 527-1/-2) | | | | | | | | | | | | | |
| Vicat B 120 (ISO | ° C. | 107 | 106 | 103 | 137 | 138 | 138 | 103 | 100 | 99 | 130 | 126 | 127 |
| 306) | | | | | | | | | | | | | |
| HDT method Af (ISO | ° C. | 89 | 88 | 84 | 118 | 118 | 112 | 85 | 81 | 77 | 110 | 102 | 98 |
| 75-1/-2) | | | | | | | | | | | | | |
| HOT method Bf (ISO | ° C. | 100 | 98 | 95 | 131 | 130 | 129 | 95 | 90 | 88 | 122 | 114 | 113 |
| 75-1/-2) | | | | | | | | | | | | | |
| UL 94 V 1.5 mm | | V0 | V0 | V0 | V0 | V0 | V0 | V0 | V0 | V1 | V0 | V0 | V0 |
| rating | | | | | | | | | | | | | |
| UL 94 V 1.5 mm | s | 7 | 9 | 25 | 8 | 12 | 9 | 12 | 22 | 81 | 10 | 9 | 27 |
| total ABT | | | | | | | | | | | | | |
| UL 94 V 3.0 mm | | V0 | V0 | V0 | V0 | V0 | V0 | V0 | V0 | V0 | V0 | V0 | V0 |
| rating | | | | | | | | | | | | | |
| UL 94 V 3.0 mm | s | 7 | 7 | 12 | 6 | 7 | 5 | 10 | 8 | 10 | 6 | 6 | 8 |
| total ABT | | | | | | | | | | | | | |

ABT = after burning time

1. Composition comprising
A) 41 to 97 parts by wt., in each case based on the sum of the parts by weight of components A+B+C+D, of at least one aromatic polycarbonate,
B) 2 to 19 parts by wt., in each case based on the sum of the parts by weight of components A+B+C+D, of at least one polyalkylene terephthalate,
C) 0.5 to 15 parts by wt., in each case based on the sum of the parts by weight of components A+B+C+D, of at least one rubber-modified graft polymer,
D) 0.5 to 25 parts by wt., in each case based on the sum of the parts by weight of components A+B+C+D, of at least one salt of a phosphinic acid.

2. Composition according to claim 1, comprising 4 to 17 parts by wt., in each case based on the sum of the parts by weight of components A+B+C+D, of a polyalkylene terephthalate according to component B

3. Composition according to claim 1, comprising 7 to 12 parts by wt., in each case based on the sum of the parts by weight of components A+B+C+D, of a salt of a phosphinic acid according to component D.

4. Composition according to claim 1, comprising 5 to 9 parts by wt., in each case based on the sum of the parts by weight of components A+B+C+D, of a rubber-modified graft polymer according to component C.

5. Composition according to claim 1, comprising 0 to 20 parts by wt., based on the sum of the parts by weight of components A+B+C+D=100, of a rubber-free vinyl (co)polymer as component E.

6. Composition according to claim 1, comprising up to 15 parts by wt., based on the sum of the parts by weight of components A+B+C+D=100, of a rubber-free vinyl (co)polymer as component E.

7. Composition according to claim 1, comprising up to 50 parts by wt. in each case based on the sum of the parts by weight of components A+B+C+D=100, of an additive as component F.

8. Composition according to claim 1, comprising as component C, at least one graft polymer of
C.1 5 to 95 wt. % of at least one vinyl monomer
C.2 95 to 5 wt. % of at least one graft base selected from the group consisting of diene rubbers, EP(D)M rubbers and acrylate, polyurethane, silicone, silicone/acrylate, chloroprene and ethylene/vinyl acetate rubbers.

9. Composition according to claim 8, comprising as C.1 a mixture of
C.1.1 50 to 99 parts by wt. of vinylaromatics and/or vinylaromatics substituted on the nucleus and/or (meth)acrylic acid (C₁-C₈)-alkyl esters and
C.1.2 1 to 50 parts by wt. of vinyl cyanides and/or (meth)acrylic acid (C₁-C₈)-alkyl esters and/or derivatives of unsaturated carboxylic acids.

10. Composition according to claim 1, wherein component B comprises polyethylene terephthalate, polybutylene terephthalate and/or polytrimethylene terephthalate.

11. Composition according to claim 1, wherein component D comprises a salt or a mixture of salts of a phosphinic acid, and having a metal cation comprising Li⁺, Na⁺, K⁺, Mg²⁺, Ca²⁺, Sr²⁺, Ba²⁺, Al³⁺, Zn²⁺, Mn²⁺, Fe²⁺ and/or Fe³⁺.

12. Composition according to claim 11, wherein a salt or a mixture of salts of a phosphinic acid of formula (IV) is employed 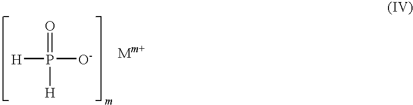
wherein
M^{m+} is a metal cation of main group 1 of alkali metals; m=1, main group 2 of alkaline earth metals; m=2 or of main group 3, m=3) or of subgroup 2, 7 or 8 of the periodic table, wherein m denotes an integer from 1 to 6.

13. Composition according to claim 12, wherein M^{m+}=Ca²⁺ and m=2 or M^{m+}=Al³⁺ and m=3.

14. Composition according to claim 1, wherein the average particle size d₅₀ of the phosphinic acid salt, component D, is not more than 80 μm.

15. Composition according to claim 1, wherein the composition is free from phosphorus-containing flameproofing agents selected from the group consisting of mono- and oligomeric phosphoric and phosphonic acid esters, phosphonate-amines and phosphazenes.

16. Composition according to claim 7, wherein said additive according to component F comprises a flameproofing synergist, antidripping agent, lubricant a mould release agent, a nucleating agent, a stabilizer, an antistatic, an acid, a filler a reinforcing substance a dyestuff and/or a pigment.

17. A method for the production of a shaped article comprising forming a composition of claim 1 into a shaped article by injection moulding, extrusion moulding, blow moulding, and/or by thermoforming from a previously produced sheet or film.

18. A shaped article comprising a composition according to claim 1.

19. Shaped article according to claim 18, wherein the shaped article is a part of a motor vehicle, rail vehicle, aircraft or aquatic vehicle and/or a film, a profile or a housing component.
